(19) United States
(12) Patent Application Publication
(10) Pub. No.: US 2018/0210924 A1
(43) Pub. Date: Jul. 26, 2018

(54) PROVIDING RELEVANT SEARCH RESULTS FROM MULTIPLE SEARCH DOMAINS BASED ON USER PROFILE DATA

(71) Applicant: International Business Machines Corporation, Armonk, NY (US)

(72) Inventors: Gordan G. Greenlee, Endicott, NY (US); Robert S. Milligan, Lexington, KY (US); Christopher L. Molloy, Raleigh, NY (US); Craig A. Nygard, Holly Springs, NC (US); Steven A. Waite, Recine, WI (US)

(21) Appl. No.: 15/416,079

(22) Filed: Jan. 26, 2017

(51) Int. Cl. G06F 17/30

(52) U.S. Cl. CPC G06F 17/30528; G06F 17/30554

(57) ABSTRACT

A method for providing relevant search results using a user's identity is provided. The method includes accessing a user profile of the user, in response to receiving a search query from the user, the user profile including information from a plurality of sources, determining a plurality of search domains based on the user profile, searching the plurality of search domains using the search query received from the user, and providing the search results from each search domain.

### BACKGROUND

The present invention relates to systems and methods of providing relevant search results when understanding the identity of the searcher, and more specifically to embodiments of a search result processing system and method that provides relevant search results from multiple search domains based on a user profile.

Current search engines assume that a search query is being made for either a name/individual or keyword.

### SUMMARY

An aspect of this invention relates to a method, and associated computer system and computer program product, for providing relevant search results based on an identity of a user. A processor of a computing system accesses a user profile of the user, in response to receiving a search query from the user, the user profile including information from a plurality of sources. A plurality of search domains are determined based on the user profile. The plurality of search domains are searched using the search query received from the user. The search results are presented from each search domain.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a block diagram of a search engine system, in accordance with embodiments of the present invention;

FIG. 2 depicts a flowchart of a method for providing relevant search results based on an identity of a user, in accordance with embodiments of the present invention;

FIG. 3 depicts a flowchart of a step of the method of FIG. 2 for providing relevant search results based on an identity of a user, in accordance with embodiments of the present invention;

FIG. 4 depicts a block diagram of a step of the method of FIG. 2, in accordance with embodiments of the present invention;

FIG. 5 illustrates a block diagram of a computer system for the search engine system of FIG. 1, capable of implementing methods for providing relevant search results based on an identity of the user of FIG. 2, in accordance with embodiments of the present invention;

FIG. 6 depicts a cloud computing environment, in accordance with embodiments of the present invention; and

FIG. 7 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

Current search engines assume that a search query is being made for either a name/individual or keyword. The searches using keywords lack context, especially when searching for an individual because the keyword search lacks context. For instance, keyword searches generally search only known domains of previously indexed material. Further, the searches for an individual are not well-supported because the scope of search is limited.

Current search technology assumes a search for either names or keywords. For a people-based workforce, the name search is not robust enough and the keyword search, while robust, lacks context. In fact, in service organizations only approximately half the keyword searches are supported by keyword-based search engines. The searches for names are not well supported because the searches for a name presuppose that the searcher know “who,” but only needs specific additional communication or contact information. As a result, the keyword searches generally search only known domains of previously indexed material. The “who” searches do not focus on workgroups or, more importantly, current work products. This is not only because of the limited scope of search, but also because of a lack of context. For example, when an a count architect for a specific client searches for information on SAP, the full context of this keyword search needs to determine the context (e.g. which account, which module) as well as the current information (e.g. Requests for Service, Change Requests or mail). Similarly, when that same architect searches for a person, the search would not necessarily include a name, but rather a role (e.g. who supports SAP), which is only minimally handled by keyword search engines.

Search engines typically deliver a set of prioritized or categorized (i.e. faceted searches) results. However, the search composer must then sort through the results for the desired information desired. For services personnel as an example, the search results need to be multi-dimensional both for a search composition as well as a search result, as provided by exemplary embodiments of the present invention. The multi-dimensional search composition may determine who is searching, such as an identity of the searcher. For instance, embodiments of the present invention may determine a home organization, a technical specialty, a set of clients served, an industry, personal details, social information, and the like, which is affiliated with or related to the searcher. The multi-dimensional search results, as opposed to traditional content searches, which access indices for selected and known information domains with an accommodation for some information about personnel, utilize a dynamic determination of the searcher's profile. The search, knowing the identity of the searcher, may extend the search to generate multiple collections of information from additional search domains. For the account architect used as an example above, the domain-specific searches may include searching request for services, problem tickets relative to the domain, technical literature for the specialty, and the like.

Thus, a need exists for a search engine that utilizes multiple search domains based upon understanding, learning, and/or knowing the identity of the searcher.

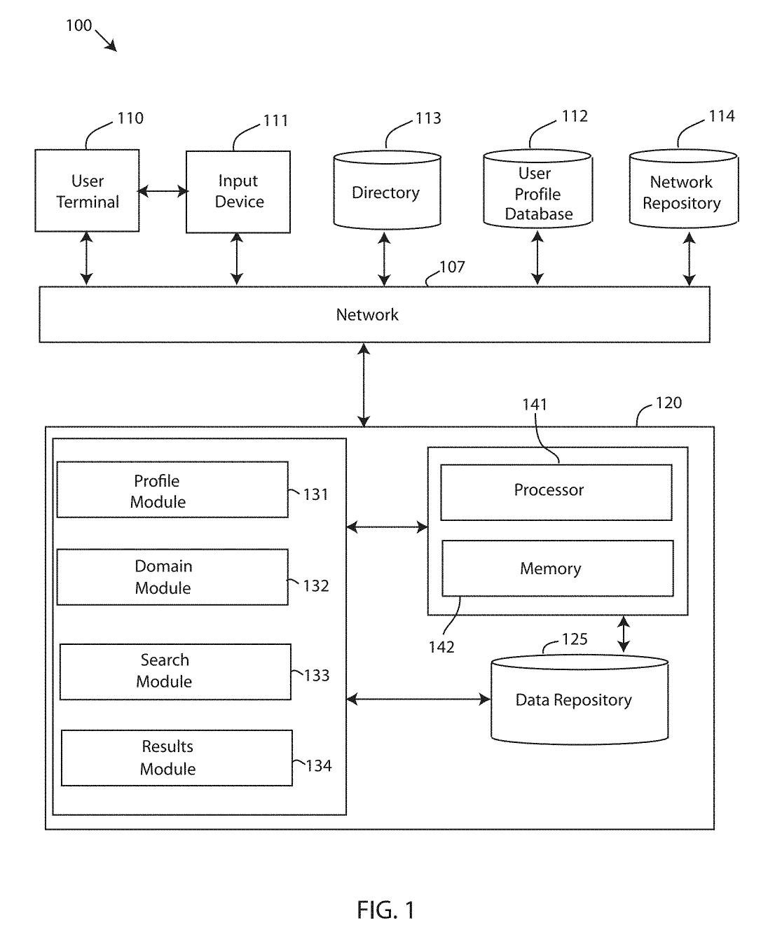

Referring to the drawings, FIG. 1 depicts a block diagram of search engine system 100, in accordance with embodiments of the present invention. Embodiments of the search engine system 100 may be described as a system for providing relevant search results from multiple search domains determined based on a user profile of the searcher. Embodiment of search engine system 100 may comprise a user terminal 110 and input device 111 communicatively coupled to a computing system 120 of the search engine system over a network 107. Embodiments of the user terminal 110 may be a computing device, such as a computer capable of running a browser to engage the computing system 120 for initiating a search query. The user terminal 110 may also transmit identifying information of the user to the computing system 120 for purposes of creating, updating, maintaining, or confirming a user profile of the user/searcher. Likewise, embodiments of the input device 111 may transmit identifying information to the computing system 120. The type of user terminal 110 and a number of input devices 111 connecting to computer system 120 over network 107 may vary from embodiment to embodiment. As shown in FIG. 1, the user terminal 110 and/or the input device 111 may transmit data about the user/searcher, such as personal information, social network information, an identity of the user, a career of the user, credentials of the user, and the like (e.g. “user-identifying data”) by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120, user terminal 110 and input device 111, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user searcher or user-identifying data sent by the user terminal 110 and/or input device 111 to generate both historical and predictive reports regarding a particular user. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may include a profile module 131, a domain module 132, a search module 133, and a results module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the profile module 131 may include one or more components of hardware and/or software program code for accessing a user profile of the user/searcher, in response to receiving a search query from the user terminal 110. The user may operate the user terminal 110 to utilize a browser application of the user terminal 110 to initiate a search query for the computing system 120 to perform search functions based on the search query. Upon receiving the search query from the user, the profile module 131 may access a user profile associated with the user requesting the search. Accessing the user profile may help learn about the identity of the user for enhancing the search results provided to the user because the searching may be provided context. Embodiments of the identity of the user may, in addition to including identifying information of the user, may include various aspects, hobbies, interest, details about the user, etc. The identity of the user may be understood from the user profile. The profile module 131 may link the user with the user profile based on an association between the user terminal 110 and the user (e.g. user is logged into a browser application loaded on the user terminal 110). Alternatively, the profile module 131 may request identifying information from the user, before accessing the user profile. For example, the profile module 131 may request data/information from the user terminal 110 (e.g. user enters pin number), or may request data/information from the input device 111, such as a mobile device to authenticate or identify the user (e.g. thumbprint sensor data). The authentication or identification may be performed at a beginning of a session or when logging into the browser, so that the user does not need to identify for each search.

Once the profile module 131 establishes a link or association between the user terminal 110 and the user, the profile module 131 may access a user profile of the user, in response to receiving the search query. The user profile may be stored on the user profile database 112, or may be accessed from the user terminal 110, or may be accessed from one or more input devices 11, such as a mobile phone. The user profile database 112 may be connected to the computing system 120 over the network 107, and may be previously established prior to the search query being received. Alternatively, the user profile may be created upon receiving the search query. In embodiments involving a previously created user profile, the profile module 131 may access the user profile by querying the user profile database 112 to locate or otherwise obtain the user profile of the user. Embodiments of the profile module 131 may also query directory 113, such as a company directory, to update, confirm, modify, augment, or supplement the user profile obtained from the user profile database 112. The user profile may be used to determine a plurality of search domains, as described in greater detail infra.

Embodiments of the user profile may be comprised of information/data from a plurality of sources. For instance, embodiments of the user profile may be established from a plurality of user profile sources. The user profile sources may be populated by the user, obtained from a company directory, such as directory 113, or assembled/created by the profile module 131 by obtaining information from other sources, or a combination thereof. Embodiments of the user profile sources used to create a user profile may include a company or corporate directory, a user-initiated private static table, a private static table built by the profile module 131, or may be various inputs provided by the user at the time of sending a search query. The plurality of user profile sources may be taken alone or together to establish a user profile, which is accessible by the profile module 131, and may be stored on the user profile database 112. Embodiments of a company or corporate directory user profile source may be created, maintained, updated, or otherwise controlled by a place of employment of the user, and may include various information/data associated with the user in the context of the user's profession, industry, role in the company, work contact information, subordinates and supervisors, colleagues, years' experience, job title, duties, work hours, and the like. Embodiments of a user-initiated, private static profile source may include data/information that the user contributes, such as optional inputs. Embodiments of optional inputs may include name, location, interests, work interests, hobbies, preferences, age, gender, personal information, background, relationships, and the like. Embodiments of a private static table built by the profile module 131 of the computing system 120 may include data/information from various accounts, social media presences/footprints, websites, profiles, etc. affiliated with and/or maintained by the user, which can be captured by the profile module 131. For example, the user's social media accounts, and the like, may be analyzed for data/information about the user to help build a user profile. In one embodiment, the profile module 131 may access publicly available information that the user posts to various websites. In another embodiment, the user may provide login credentials to the profile module 131 for accessing private areas of various websites. Embodiments of the profile module 131 may also receive input from the user at the time of initiating the search query. These various sources may be used to determine the user profile. In an exemplary embodiment, the profile module 131 of the computing system 120 may create, maintain, update, and/or establish the user profile, which may be accessed via user profile database 112 in response to receiving the search query.

In further embodiments, the user profile may include data/information captured by one or more input devices, such as input device 111. In other words, embodiments of input device 111 may be another source for the user profile. In an exemplary embodiment, data received by the profile module 131 from the input device 111 may be received in real-time to modify, confirm, augment, bolster, or otherwise enhance the user profile of the user at the time of searching. Embodiments of the computing system 120 may receive user data from the input device 111, which may be positioned within an environment shared by the user, worn by the user, or otherwise disposed in a location that can result in obtaining user data. Input device 111 may be a sensor, an input device, or any input mechanism. For example, input device 111 may be a biometric sensor, a wearable sensor, an environmental sensor, a camera, a camcorder, a microphone, a peripheral device, a computing device, a mobile computing device, such as a smartphone or tablet, facial recognition sensor, voice capture device, and the like. Embodiments of input device 111 may also include a heart rate monitor used to track a current or historical average heart rate of the user; wireless-enabled wearable technology, such as an activity tracker or smartwatch that tracks a heart rate; a blood pressure monitor; a perspiration sensor; and other wearable sensor hardware. Further embodiments of input device 111 not specifically listed herein may be utilized to collect user data.

Further embodiments of input device 111 may include one or more input devices or input mechanisms, including one or more microphones positioned nearby the user to collect audio relating to the user (or for receiving real-time inputs), and other hardware input devices, such as an audio conversion device, digital camera or camcorder, voice recognition devices, graphics tablet, a webcam, VR equipment, mouse, touchpad, stylus, and the like, which may help understand the user. Further embodiments of input device 111 may include a mobile computing device, such as a smartphone or tablet device, which may run various applications that contain data about the user. For example, a user's smartphone may be used as a sensor, and may also utilize the device's camera, microphone, and other embedded sensors to send information to the computing system 120. Moreover, embodiments of input device 111 may encompass other input mechanisms, such as a user computer that may send information to the computing system 120, wherein the user computer may be loaded with software programs that are designed to capture various inputs/data about the user. Further, embodiments of the input device 111 may also communicate with the user terminal 110 to send data/information to the profile module 131 in response to the profile module 131 accessing the user profile.

Embodiments of the computing system 120 may also include a domain module 132. Embodiments of the domain module 132 may include one or more components of hardware and/or software program code for determining a plurality of search domains, based on the user profile created and/or accessed by the profile module 131. The domain module 132 may determine one or more search domains based on the user profile for performing the search for the search query received from the user. Embodiments of the search domains may provide a unique context for searching a particular search string, wherein the context is directly related or at least affiliated with the user. In an exemplary embodiment, each search domain may categorize an aspect of the user that may result in different search results than in other search domains. Moreover, the plurality of search domains, determined by the domain module 132, based on the user profile, may each provide a unique context for responding to the search query received from the user. The plurality of search domains may be personalized to the user so that multiple search streams may be created in view of an identity of the user.

Embodiments of search domains may include a general search domain, a profession or career search domain, a social network search domain, a company-based search domain, or any search domain defined by one or more aspect of the user, derived from the user profile. Embodiments of a general search domain may include a search domain that focuses on a more general search, which may be similar to a typical search, but may also analyze and apply general information regarding the user, such as age, gender, geographic location, birthplace, user preferences, sports interests, and the like. Embodiments of a professional or career search domain may include a search domain that focuses on a professional network or career-related issues pertaining to the user. For example, the profession search domain may filter results bases on group memberships of the user, the user's profession, the user's associates, the user's clients served, the user's own work, an organization that the user belongs to, past employers of the user, individuals that have worked with or have hired the user, and the like. Collaborative spaces containing the user's work product may be searched, as well a search against real-time systems authorized to the search engine by the user, and designated work or career related organizations. Embodiments of a social network search domain may include a search domain that focuses on a social aspect/context of the user. For example, the social network search domain may search for the search query received by the user in a variety of social network platforms. In addition, the social network search domain may filter results based on friends' networks, relationships, political leanings gathered from Twitter posts or Facebook posts, and the like. Embodiments of a company search domain may include a search domain that focuses on searching a company directory, such as directory 113, which may be the place of employment of the user, a customer of the user, a business partner of the user, and the like.

Further, embodiments of the search domains be predetermined, derived from the user profile. For example, an organization or entity that the user belongs to, is affiliated with, or employed by, may specify data sources for the search domain to interrogate. In another embodiment, a services professional (user) may imply a search of services assets in repositories of services offerings, further utilizing the understanding of the user. User work groups may also be matched on both a general and specific layer. As an example, a user work group may be matched with tables for search facets both generic (e.g. infrastructure) and specific (e.g. network architect), wherein each work group may specify the work group's domains as a list of collaborative spaces where peers of the user hangout. Select sources may be searched for a particular profession, wherein each profession may specify both public and corporate collaborate hangouts. Collaborative spaces may often tag content with user or user group information, and a list of specific tags may direct a prioritization of the search in the collaborative spaces. Further, search sources may be tagged with a client name, and each client enterprise may designate repositories for the search. In a corporate application, the repositories may be the source of real-time information about a condition, similar to a ticket system. Various functions may be utilized by the plurality of search domains, wherein the context for each search domain may be based upon the user profile.

Furthermore, embodiments of the computing system 120 may further include search module 133 for searching the plurality of search domains using the search query received from the user. Embodiments of the search module 133 may refer to configurations of hardware, software program code, or combinations of hardware and software programs, capable of searching the plurality of search domains for the search query received from the user.

With continued reference to FIG. 1, embodiments of the computing system 120 may include a results module 134. Embodiments of the results module 134 may include one or more components of hardware and/or software program code for organizing, displaying, presenting, etc. the results from the searching of the plurality of search domains. For instance, embodiments of the results module 134 may transmit the results of the user's search query to the user terminal 110. The results may then be presented, displayed, or otherwise provided to the user. Embodiments of the results module 134 may output the search results for each search domain. In other words, the results module 134 may organize the search results in a plurality of search streams, wherein each search stream or result may be associated with a search domain. The results module 134 may present the user with an option to select one or more search domain results. The user may then select one or more search domain results on the user terminal 110 such that a browser application on the user terminal 110 presents the selected search results. In some embodiments, the results module 134 may output search results using one or more graphical representations.

Referring still to FIG. 1, embodiments of the computer system 120 may be equipped with a memory device 142 which may store the user data, search queries, search domain determinations, search results, and the like, and a processor 141 for implementing the tasks associated with the search engine system 100.

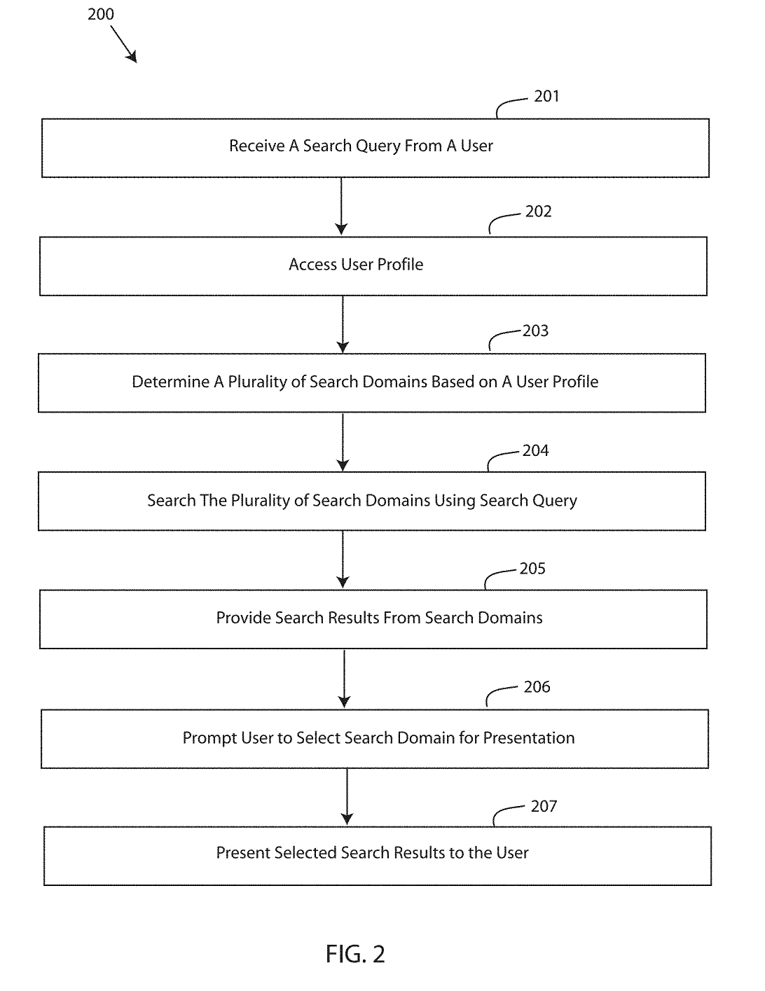

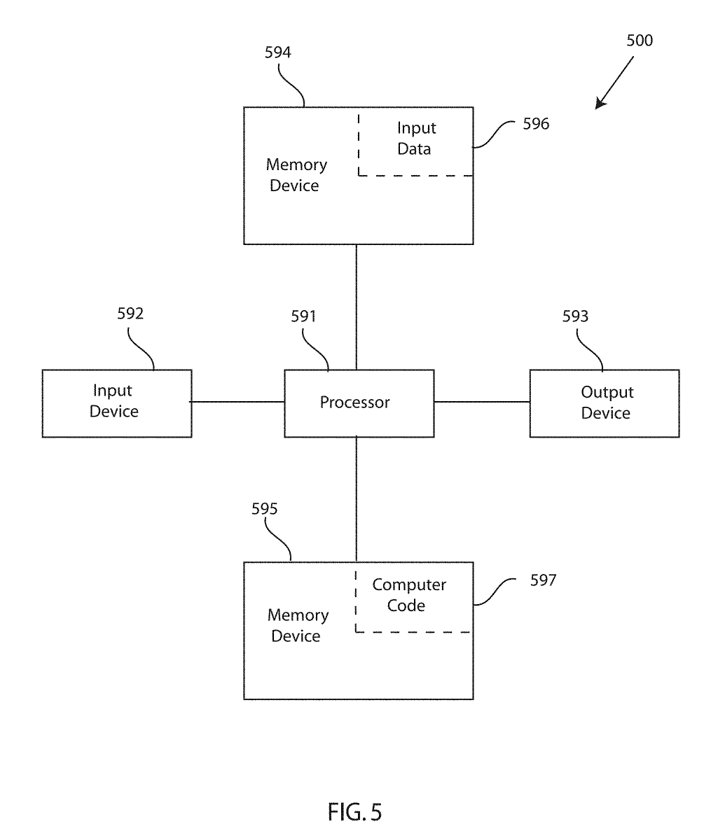

Referring now to FIG. 2, which depicts a flow chart of a method 200 for providing relevant search results based on an identity of a user, in accordance with embodiments of the present invention. One embodiment of a method 200 or algorithm that may be implemented for providing relevant search results based on an identity of a user in accordance with the search engine system 100 described in FIG. 1 using one or more computer systems as defined generically in FIG. 5 below, and more specifically by the specific embodiments of FIG. 1.

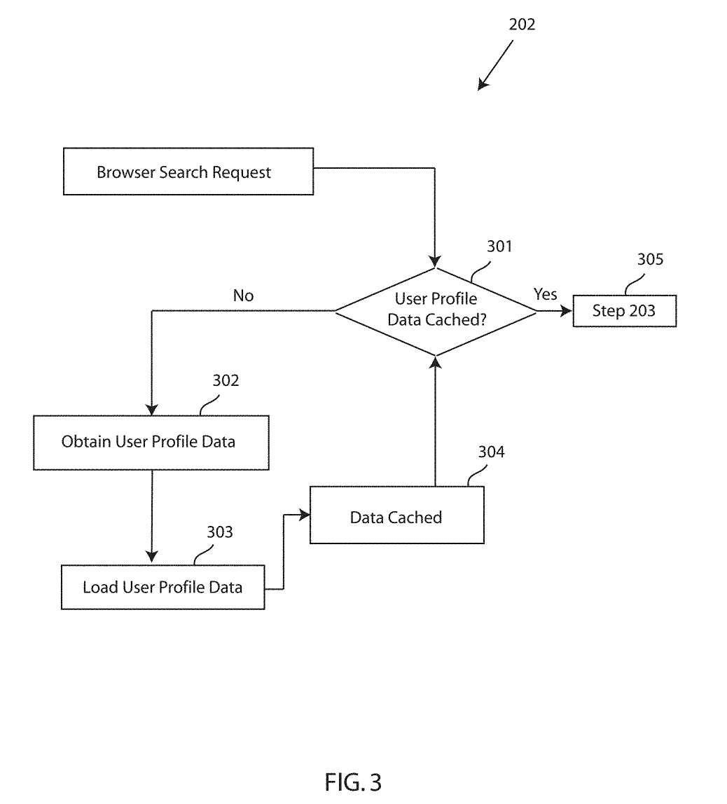

Embodiments of the method 200 for providing relevant search results based on an identity of a user may begin at step 201 wherein a search query is received by the computing system 120. The search query may be made by the user operating a user terminal 110, such as a computer, smartphone, tablet computer, or any computing capable of executing browser and connecting to the computing system 120 over network 107. The search query may include a plurality of keywords, and may be a search for an individual. Step 202 accesses a user profile of the user, in response to receiving the search query. The user profile may be accessed over the network 107, or may be loaded from a local storage, such as data repository 125. In an exemplary embodiment, the user profile may be obtained by accessing the user profile database 112, or one or more remote servers or computing devices that may include data/information of the user. Accessing the user profile may help understand and learn about various facets of the user, which may provide several various contexts to the search query. FIG. 3 depicts a flowchart of a step of the method of FIG. 2 for providing relevant search results based on an identity of a user, in accordance with embodiments of the present invention. The step 202 of accessing a user profile includes step 301, which determines whether user profile data is cached. If yes, then the method 200 continues to step 203. If the data is not cached, then step 303 obtains the user profile data 302 (e.g. from user profile database 112). Step 303 loads the user data profile, and step 304 caches the data, and the method 200 may continue to step 203.

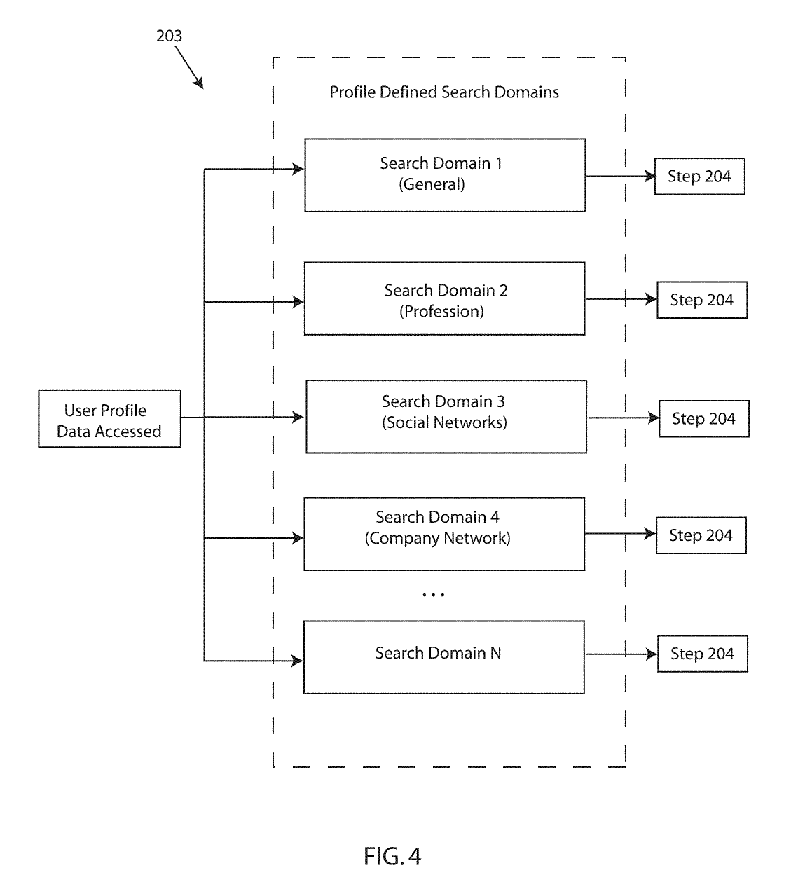

Referring back to FIG. 2, step 203 determines a plurality of search domains based on the user profile. The plurality of search domains may be defined by one or more aspects of the user profile, which may provide context to the search query received by the user. FIG. 4 depicts a block diagram of step 203 of method 200, in accordance with embodiments of the present invention. Based on the user profile, a plurality of profile-defined search domains may be determined by step 203. Embodiments of the profile-defined search domains may include a general search domain, a profession or career search domain, a social network search domain, a company-based search domain, or any search domain defined by one or more aspect of the user, derived from the user profile. Each of the plurality of search domains may be searched. Specifically, step 204 as depicted in FIG. 2 searches the plurality of search domains using the search query received from the user. Step 205 provides the search results for each search domain. In an exemplary embodiment, the results from the search for each search domain are presented to the user terminal 110. In another embodiment, step 206 prompts the user to select one or more search domains that the user is interested in reviewing the results therefrom. For instance, if the user is searching for a colleague of the user's employer that works in an office in another state, the user may select the corporate/company search domain, which may be more likely to contain relevant results, given the context of the user. Because the system 100 understands the user, and knows that the user works at a given employer, certain directories may be searched that may not have been searched in a general search domain. In response to the user selecting the search domain, step 207 presents the results to the user. The presentation may be indexed results, or may be a graphical representation.

FIG. 5 illustrates a block diagram of a computer system 500 that may be included in the system of FIG. 1 and for implementing the methods of FIGS. 2-4 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the took and programs capable of implementing a method for providing relevant search results based on an identity of a user, in the manner prescribed by the embodiments of FIGS. 2-4 using the search engine system of FIG. 1, wherein the instructions of the computer code 597 may be executed by processor 591 via memory device 595. The computer code 597 may include software or program instructions that may implement one or more algorithms for implementing the methods for providing relevant search results based on an identity of a user, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

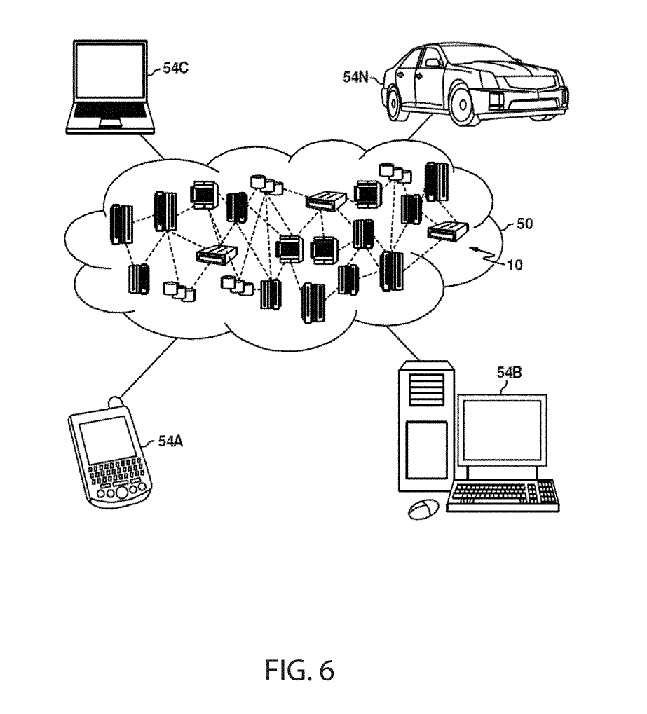

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to content rating systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processors) 591, wherein the processor(s) carry out instructions contained in the computer code 597 causing the computer system to provide relevant search results based on an identity of a user. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for providing relevant search results based on an identity of a user. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for providing relevant search results based on an identity of a user.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 6 are intended to be illustrative only and that computing nodes 10 and cloud computing environment 50 can communicate with any type of computerized device over any type of network and/or network addressable connection (e.g., using a web browser).

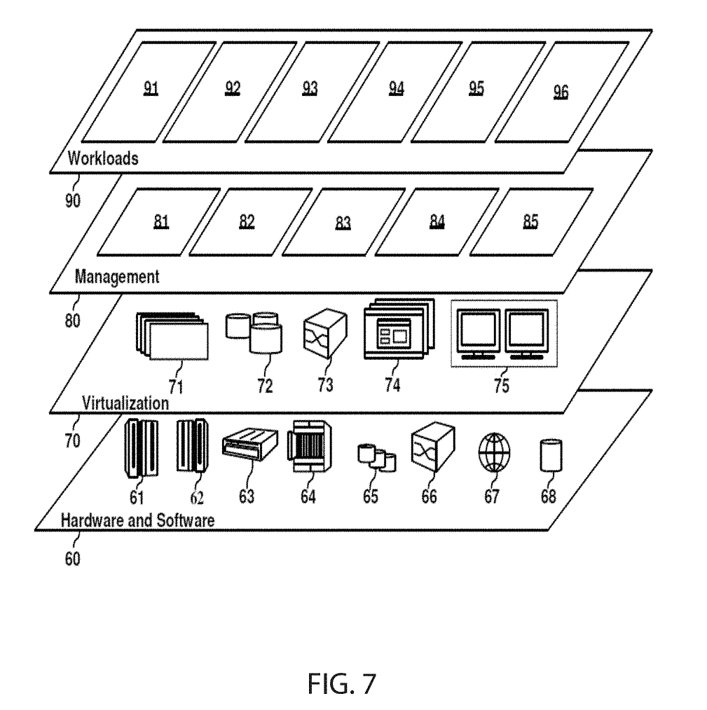

Referring now to FIG. 7, a set of functional abstraction layers provided by cloud computing environment 50 (see FIG. 6) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and relevant search delivery based on user identity 96.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein

1. A method for providing relevant search results based on an identity of a user, the method comprising:
accessing, by a processor of a computing system, a user profile of the user, in response to receiving a search query from the user, the user profile including information from a plurality of sources;
determining, by the processor, a plurality of search domains based on the user profile;
searching, by the processor, the plurality of search domains using the search query received from the user; and
providing, by the processor, the search results from each search domain.

2. The method of claim 1, further comprising prompting, by the processor, the user to select one or more search domains from the plurality of search domains; and presenting, by the processor, the search results associated with the selected search domain.

3. The method of claim 1, wherein the user profile includes one or more aspect of the user to define the identity of the user to provide context to the search query.

4. The method of claim 1, wherein the plurality of search domains includes a general search domain, a profession search domain, a social network domain, and a company network domain.

5. The method of claim 1, wherein the plurality of sources are predetermined.

6. The method of claim 1, wherein the plurality of sources include an input device.

7. The method of claim 5, wherein information received from the input provides a real-time update to the user profile.

8. A computer system, comprising:
a processor;
a memory device coupled to the processor; and
a computer readable storage device coupled to the processor, wherein the storage device contains program code executable by the processor via the memory device to implement a method for providing relevant search results based on an identity of a user, the method comprising:
accessing, by a processor of a computing system, a user profile of the user, in response to receiving a search query from the user, the user profile including information from a plurality of sources;
determining, by the processor, a plurality of search domains based on the user profile;
searching, by the processor, the plurality of search domains using the search query received from the user; and
providing, by the processor, the search results from each search domain.

9. The computer system of claim 8, further comprising prompting, by the processor, the user to select one or more search domains from the plurality of search domains; and presenting, by the processor, the search results associated with the selected search domain.

10. The computer system of claim 8, wherein the user profile includes one or more aspect of the user to define the identity of the user to provide context to the search query.

11. The computer system claim 8, wherein the plurality of search domains includes a general search domain, a profession search domain, a social network domain, and a company network domain.

12. The computer system of claim 8, wherein the plurality of sources are predetermined.

13. The computer system of claim 8, wherein the plurality of sources include an input device.

14. The computer system of claim 13, wherein information received from the input provides a real-time update to the user profile.

15. A computer program product, comprising a computer readable hardware storage device storing a computer readable program code, the computer readable program code comprising an algorithm that when executed by a computer processor of a computing system implements a method for providing relevant search results based on an identity of a user, comprising:
accessing, by a processor of a computing system, a user profile of the user, in response to receiving a search query from the user, the user profile including information from a plurality of sources;
determining, by the processor, a plurality of search domains based on the user profile;
searching, by the processor, the plurality of search domains using the search query received from the user; and
providing, by the processor, the search results from each search domain.

16. The computer program product of claim 15, further comprising prompting, by the processor, the user to select one or more search domains from the plurality of search domains; and presenting, by the processor, the search results associated with the selected search domain.

17. The computer program product of claim 15, wherein the user profile includes one or more aspect of the user to define the identity of the user to provide context to the search query.

18. The computer program product of claim 15, wherein the plurality of sources are predetermined.

19. The computer program product of claim 15, wherein the plurality of sources include an input device.

20. The computer program product of claim 19, wherein information received from the input provides a real-time update to the user profile.
